(19) United States
(12) Patent Application Publication
(10) Pub. No.: US 2020/0309560 A1
(43) Pub. Date: Oct. 1, 2020

(54) CONTROL APPARATUS, CONTROL METHOD, AND STORAGE MEDIUM

(71) Applicant: HONDA MOTOR CO., LTD., Tokyo (JP)

(72) Inventors: Hideki MATSUNAGA, Wako-shi (JP); Masaru OTAKA, Wako-shi (JP); Masamitsu TSUCHIYA, Wako-shi (JP); Toshiaki TAKANO, Tokyo (JP); Satoshi ONODERA, Tokyo (JP)

(21) Appl. No.: 16/828,397

(22) Filed: Mar. 24, 2020

(30) Foreign Application Priority Data
Mar. 29, 2019 (JP) 2019-067124

(51) Int. Cl. G01C 21/36; G06F 3/14; B60K 35/00

(52) U.S. Cl. CPC G01C 21/3647; B60K 35/00; G06F 3/14

(57) ABSTRACT

A control apparatus that controls a display apparatus of a mobile body to which a remote operation service is provided from a remote operation apparatus is provided. The apparatus includes an acquisition unit configured to acquire information that is generated by the remote operation apparatus and is displayed on a display apparatus of the remote operation apparatus, and a control unit configured to display the information on the display apparatus of the mobile body.

### CROSS-REFERENCE TO RELATED APPLICATION(S)

This application claims priority to and the benefit of Japanese Patent Application No. 2019-067124 filed on Mar. 29, 2019, the entire disclosure of which is incorporated herein by reference.

### BACKGROUND OF THE INVENTION

### Field of the Invention

The present invention relates to a control apparatus, a control method, and a storage medium.

### Description of the Related Art

Various techniques related to a remote driving service for remotely driving a vehicle have been proposed. Japanese Patent No. 6418181 proposes a technique for displaying an image of an operator of a remote driving apparatus, also known as a tele-operated driving apparatus, on a display apparatus of a vehicle in order to increase a sense of safety of the driver of the vehicle.

### SUMMARY OF THE INVENTION

According to the technique of Japanese Patent No. 6418181, the driver of the vehicle can be aware of the appearance of the operator of the remote driving apparatus. However, the driver cannot be aware, from the image of the operator, how the vehicle is to be driven. Some aspects of the present invention provide a technique for improving a sense of safety of the user of a mobile body to which a remote operation service is provided.

In light of the above-described issue, a control apparatus that controls a display apparatus of a mobile body to which a remote operation service is provided from a remote operation apparatus, and includes an acquisition unit configured to acquire information that is generated by the remote operation apparatus and is displayed on a display apparatus of the remote operation apparatus, and a control unit configured to display the information on the display apparatus of the mobile body is provided.

### BRIEF DESCRIPTION OF THE DRAWINGS

FIG. 1 is a block diagram illustrating a configuration example of a vehicle according to an embodiment of the present invention.

FIG. 2 is a block diagram illustrating a configuration example of a remote driving apparatus according to an embodiment of the present invention.

FIG. 3 is a schematic diagram illustrating a console example of remote driving according to an embodiment of the present invention.

FIG. 4 is a schematic diagram illustrating a real environment around a vehicle according to an embodiment of the present invention.

FIG. 5 is a timing chart illustrating an operation example in a remote control system according to an embodiment of the present invention.

FIG. 6 is diagram illustrating exemplary display images of a remote driving apparatus and a vehicle according to an embodiment of the present invention.

FIG. 7 is a diagram illustrating exemplary display images of a remote driving apparatus and a vehicle according to an embodiment of the present invention.

### DESCRIPTION OF THE EMBODIMENTS

Hereinafter, embodiments will be described in detail with reference to the attached drawings. Note that the following embodiments are not intended to limit the scope of the claimed invention, and limitation is not made an invention that requires all combinations of features described in the embodiments. Two or more of the multiple features described in the embodiments may be combined as appropriate. Furthermore, the same reference numerals are given to the same or similar configurations, and redundant description thereof is omitted.

A vehicle 1 includes a vehicle control apparatus 2 (hereinafter, simply referred to as “control apparatus 2”) that controls the vehicle 1. The control apparatus 2 includes a plurality of ECUs 20 to 29 that are communicably connected by an in-vehicle network. Each of the ECUs includes a processor represented by a CPU, a memory such as a semiconductor memory, an interface to an external device, and the like. The memory stores programs that are executed by the processor, data that is used by the processor to perform processing, and the like. Each of the ECUs may include a plurality of processors, memories, interfaces, and the like. For example, the ECU 20 includes a processor 20a and a memory 20b. Processing that is performed by the ECU 20 is executed as a result of the processor 20a executing an instruction included in a program stored in the memory 20b. Alternatively, the ECU 20 may include a dedicated integrated circuit such as an ASIC for executing processing that is performed by the ECU 20. The same applies to the other ECUs.

Functions allocated to the (respective) ECUs 20 to 29, and the like will be described below. Note that the number of ECUs and functions allocated to the ECUs can be designed as appropriate, and can be segmentalized further than those in this embodiment, or can be integrated.

The ECU 20 executes running control related to an automated driving function and a remote driving function of the vehicle 1. In this running control, the ECU 20 automatically controls steering and/or acceleration/deceleration of the vehicle 1. The automated driving function is a function of the ECU 20 planning a running route of the vehicle 1, and controlling steering and/or acceleration/deceleration of the vehicle 1 based on this running route. The remote driving function is a function of the ECU 20 controlling steering and/or acceleration/deceleration of the vehicle 1 in accordance with an instruction from an operator outside the vehicle 1. The operator outside the vehicle 1 may be a human or an AI (artificial intelligence). The ECU 20 can execute the automated driving function and the remote operation function in combination. For example, a configuration may also be adopted in which the ECU 20 plans a running route and performs running control when there is no instruction from an operator, and when there is an instruction from an operator, performs running control in accordance with the instruction.

The ECU 21 controls an electronic power steering apparatus 3. The electronic power steering apparatus 3 includes a mechanism for steering front wheels according to a driver's driving operation (steering operation) on a steering wheel 31. The electronic power steering apparatus 3 also includes a motor that exerts drive force for assisting a steering operation and automatically steering the front wheels, a sensor that detects a steering angle, and the like. When the driving state of the vehicle 1 is an automated driving state, the ECU 21 automatically controls the electronic power steering apparatus 3 according to an instruction from the ECU 20, and controls the direction of forward movement of the vehicle 1.

The ECUs 22 and 23 control detection units 41 to 43 that detect the situation of the outside of the vehicle, and perform information processing on detection results. Each detection unit 41 is a camera for shooting an image ahead of the vehicle 1 (which may hereinafter be referred to as “camera 41”), and, in this embodiment, is installed at a roof front part and on an interior side of the front window. By analyzing an image shot by a camera 41, it is possible to extract the contour of an object and a demarcation line (white line, for example) of a traffic lane on a road.

Each detection unit 42 is a LIDAR (Light Detection and Ranging, may hereinafter be referred to as “LIDAR 42”), detects an object in the surroundings of the vehicle 1, and measures the distance from the object. In this embodiment, five LIDARs 42 are provided, two of the five LIDARs 42 being provided at the respective front corners of the vehicle 1, one at the rear center, and two on the respective sides at the rear. Each detection unit 43 is a millimeter-wave radar (which may hereinafter be referred to as “radar 43”), detects an object in the surroundings of the vehicle 1, and measures the distance from a marker. In this embodiment, five radars 43 are provided, one of the radars 43 being provided at the front center of the vehicle 1, two at the respective front corners, and two at the rear corners.

The ECU 22 controls one camera 41 and the LIDARs 42, and performs information processing on their detection results. The ECU 23 controls the other camera 41 and the radars 43, and performs information processing on their detection results. By providing two sets of apparatuses that detect the surrounding situation of the vehicle, the reliability of detection results can be improved, and by providing detection units of different types such as cameras, LIDARs, and radars, the surrounding environment of the vehicle can be multilaterally analyzed.

The ECU 24 controls a gyro sensor 5, a GPS sensor 24b, and a communication apparatus 24c, and performs information processing on their detection results or communication results. The gyro sensor 5 detects rotary movement of the vehicle 1. A course of the vehicle 1 can be determined based on a detection result of the gyro sensor 5, a wheel speed, and the like. The GPS sensor 24b detects the current position of the vehicle 1. The communication apparatus 24c wirelessly communicates with a server that provides map information and traffic information, and acquires such information. The ECU 24 can access a database 24a of map information built in the memory, and the ECU 24 searches for a route from the current location to a destination, and the like. The ECU 24, the map database 24a, and the GPS sensor 24b constitute a so-called navigation apparatus.

The ECU 25 includes a communication apparatus 25a for inter-vehicle communication. The communication apparatus 25a wirelessly communicates with another vehicle in the surroundings thereof, and exchanges information with the vehicle. The communication apparatus 25a is also used for communication with an operator outside the vehicle 1.

The ECU 26 controls a power plant 6. The power plant 6 is a mechanism for outputting drive force for rotating the drive wheels of the vehicle 1, and includes an engine and a transmission, for example. For example, the ECU 26 controls output of the engine in accordance with a driver's driving operation (an accelerator operation or an accelerating operation) detected by an operation detection sensor 7a provided on an accelerator pedal 7A, and switches the gear stage of the transmission based on information regarding the vehicle speed detected by a vehicle speed sensor 7c. When the driving state of the vehicle 1 is an automated driving state, the ECU 26 automatically controls the power plant 6 in accordance with an instruction from the ECU 20, and controls the acceleration/deceleration of the vehicle 1.

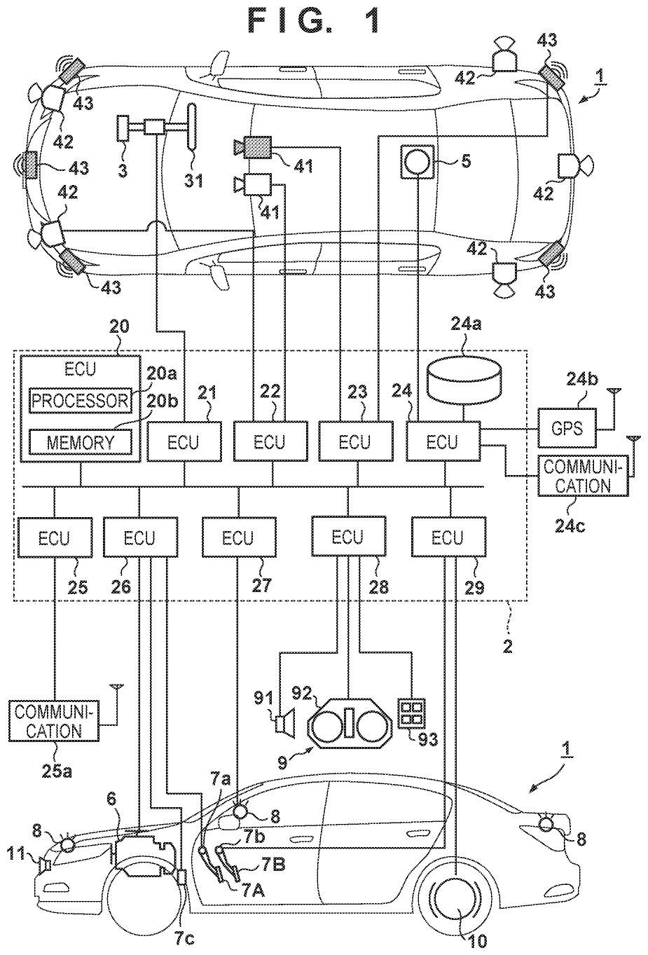

The ECU 27 controls illumination apparatuses 8 (lights such as headlights and taillights) that include direction indicators (blinkers). In the example in FIG. 1, the illumination apparatuses 8 are provided on door mirrors, at the front, and at the rear of the vehicle 1. The ECU 27 further controls an acoustic apparatus 11 that includes a horn and is directed to the outside of the vehicle. The illumination apparatuses 8, the acoustic apparatus 11, or a combination thereof has a function of providing information to the outside the vehicle 1.

The ECU 28 controls an input/output apparatus 9. The input/output apparatus 9 outputs information to the driver, and receives information from the driver. An audio output apparatus 91 notifies the driver of information using sound. A display apparatus 92 notifies the driver of information through image display. The display apparatus 92 is installed in front of the driver's seat, for example, and constitutes an instrument panel, or the like. Note that, here, sound and display are illustrated, but information may be notified using vibration and light. In addition, information may also be notified using a combination of some of sound, display, vibration, and light. Furthermore, the combination or a notification aspect may be different according to the level of information to be notified (for example, an emergency level). Input apparatuses 93 are a group of switches arranged at positions so as to enable the driver to perform an operation on the switches to give an instruction to the vehicle 1, but may include an audio input apparatus. The ECU 28 can give guidance related to running control of the ECU 20. The guidance will be described later in detail. The input apparatuses 93 may also include a switch used for controlling an operation of running control by the ECU 20. The input apparatuses 93 may also include a camera for detecting the direction of a line of sight of the driver.

The ECU 29 controls a brake apparatus 10 and a parking brake (not illustrated). The brake apparatus 10 is, for example, a disk brake apparatus, is provided for each of the wheels of the vehicle 1, and decelerates or stops the vehicle 1 by imposing resistance to rotation of the wheels. The ECU 29 controls activation of the brake apparatus 10, for example, in accordance with a driver's driving operation (brake operation) detected by an operation detection sensor 7b provided on a brake pedal 7B. When the driving state of the vehicle 1 is an automated driving state, the ECU 29 automatically controls the brake apparatus 10 in accordance with an instruction from the ECU 20, and controls deceleration and stop of the vehicle 1. The brake apparatus 10 and the parking brake can also be activated to maintain a stopped state of the vehicle 1. In addition, if the transmission of the power plant 6 includes a parking lock mechanism, this can also be activated in order to maintain a stopped state of the vehicle 1.

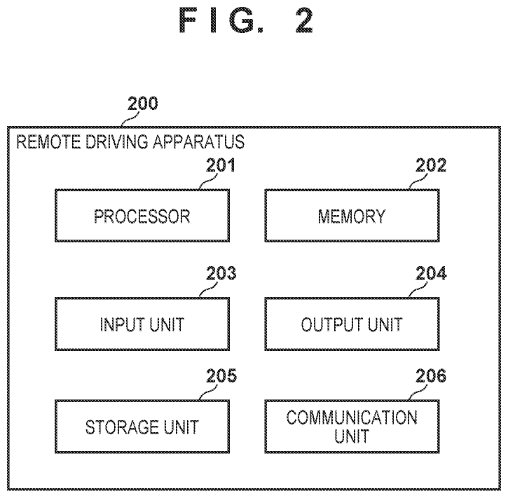

A configuration of a remote driving apparatus 200 according to some embodiments of the present invention will be described with reference to the block diagram in FIG. 2. The remote driving apparatus 200 is an apparatus that provides a remote driving service to a vehicle that has a remote driving function. The remote driving apparatus 200 is positioned at a remote location from a vehicle to which the service is provided.

The remote driving apparatus 200 may be able to provide the remote driving service in a plurality of operation modes. The plurality of operation modes of the remote driving service may include a leading mode and an assisting mode. The leading mode refers to an operation mode in which the operator of the remote driving apparatus 200 specifies control amounts (for example, a steering angle, an accelerator pedal position, a brake pedal position, a position of the directional signal lever, and on/off of the lights) of the vehicle. The assisting mode refers to an operation mode in which the vehicle (specifically, the ECU 20) determines control amounts of the vehicle in accordance with a path plan specified by the operator of the remote driving apparatus 200. In the assisting mode, the operator of the remote driving apparatus 200 may generate and designate a path plan for themselves, or may adopt and designate a path plan suggested by the vehicle.

The remote driving apparatus 200 includes constituent elements shown in FIG. 2. A processor 201 controls overall operations of the remote driving apparatus 200. The processor 201 functions as a CPU, for example. A memory 202 stores programs that are used for operations of the remote driving apparatus 200, temporary data, and the like. The memory 202 is realized by a ROM and a RAM, for example. An input unit 203 is used by the user of the remote driving apparatus 200 to perform input to the remote driving apparatus 200. When a human operates the remote driving apparatus 200, the user of the remote driving apparatus 200 is this human, and when an AI operates the remote driving apparatus 200, the user of the remote driving apparatus 200 is a human (monitoring person) that monitors operations of the AI. An output unit 204 is used for outputting information from the remote driving apparatus 200 to the user. A storage unit 205 stores data used for operations of the remote driving apparatus 200. The storage unit 205 is realized by a storage apparatus such as a disk drive (for example, an HDD or an SSD). A communication unit 206 provides a function of the remote driving apparatus 200 communicating with another apparatus (for example, a vehicle to be remotely driven), and is realized by a network card or an antenna, for example.

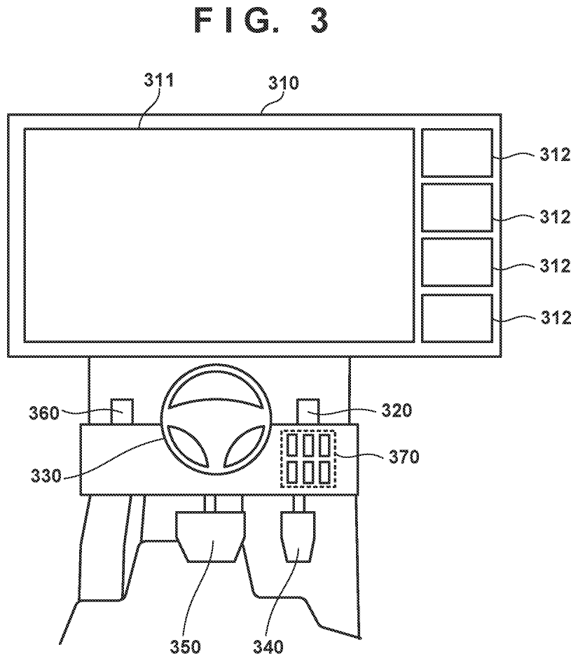

A configuration example of the input unit 203 and the output unit 204 of the remote driving apparatus 200 will be described with reference to the schematic diagram in FIG. 3. In this configuration example, the output unit 204 is constituted by a display apparatus 310 and an acoustic apparatus 320, and the input unit 203 is constituted by a steering wheel 330, an accelerator pedal 340, a brake pedal 350, a microphone 360, and a plurality of switches 370.

The display apparatus 310 is an apparatus that outputs visual information for providing the remote driving service. The acoustic apparatus 320 is an apparatus that outputs audio information for providing the remote driving service. A screen displayed on the display apparatus 310 includes one main region 311 and a plurality of sub regions 312. Information regarding a vehicle to be controlled from among a plurality of vehicles to which the remote driving service is to be provided is displayed in the main region 311. The vehicle to be controlled is a vehicle to which an instruction from the remote driving apparatus 200 is transmitted. Information regarding a vehicle other than the vehicle to be controlled from among the plurality of vehicles to which the remote driving service is provided is displayed in each of the sub regions 312. A vehicle other than the vehicle to be controlled may be called a “vehicle to be monitored”. When one remote driving apparatus 200 provides the remote driving service to a plurality of vehicles, the operator switches a vehicle displayed on the main region 311 (i.e., the vehicle to be controlled) as appropriate. Information displayed on the main region 311 and the sub regions 312 includes the traffic condition in the surrounding of the vehicle, the speed of the vehicle, and the like.

The steering wheel 330 is used for controlling the steering amount of the vehicle to be controlled, in the leading mode. The accelerator pedal 340 is used for controlling the accelerator pedal position of the vehicle to be controlled, in the leading mode. The brake pedal 350 is used for controlling the brake pedal position of the vehicle to be controlled, in the leading mode. The microphone 360 is used for inputting audio information. Audio information input to the microphone 360 is transmitted to the vehicle to be controlled, and is regenerated in the vehicle.

The plurality of switches 370 are used for inputting various types of instructions for providing the remote driving service. For example, the plurality of switches 370 include a switch for switching the vehicle to be controlled, a switch for performing an instruction of a determination result of the operator in the assisting mode, a switch for switching a plurality of operation modes, and the like.

The remote driving apparatus 200 described with reference to FIGS. 2 and 3 can provide both the leading mode and the assisting mode. Alternatively, the remote driving apparatus 200 can provide only one of the leading mode and the assisting mode. When the leading mode is not provided, the steering wheel 330, the accelerator pedal 340, and the brake pedal 350 can be omitted. In addition, the remote driving service may be provided by a plurality of remote driving apparatuses 200 in cooperation. A configuration may be adopted, in this case, a remote driving apparatus 200 can take over a vehicle to which the service is to be provided, from another remote driving apparatus 200.

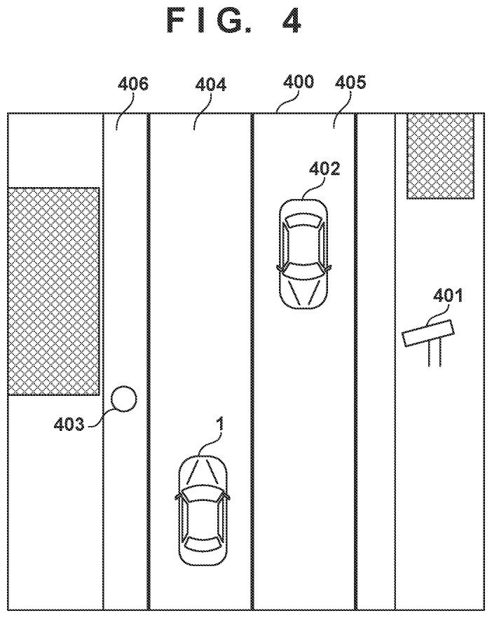

An example of a real environment 400 (environment in the real world) around the vehicle 1 to be remotely driven will be described with reference to FIG. 4. Assume that the vehicle 1 is running on a traffic lane 404 in accordance with an operation instruction from the remote driving apparatus 200. An oncoming vehicle 402 is running on an oncoming lane 405 opposite to the traffic lane 404. The oncoming vehicle 402 may be manually driven by a driver, may be running using an automated driving function, or may be running using a remote driving service different from that of the remote driving apparatus 200. However, assume that the oncoming vehicle 402 is not operated by the remote driving apparatus 200.

A pedestrian 403 is walking on a sidewalk 406 adjacent to the traffic lane 404. A road management camera 401 is installed to shoot an image of the traffic lane 404 and the oncoming lane 405. The oncoming vehicle 402 and the pedestrian 403 are in the surroundings of the vehicle 1, and are examples of an object that is not to be operated by the remote driving apparatus 200, and can autonomously move. Hereinafter, an object that is not to be operated by the remote driving apparatus 200, and can autonomously move is referred to as an “autonomously movable object”. Hereinafter, an autonomously movable object is simply referred to as an “object”. The surroundings of the vehicle 1 may refer to a detectable range of the detection units 41 to 43 of the vehicle 1, or a range that is displayed as the surroundings of the vehicle 1, on the display apparatus 310 of the remote driving apparatus 200.

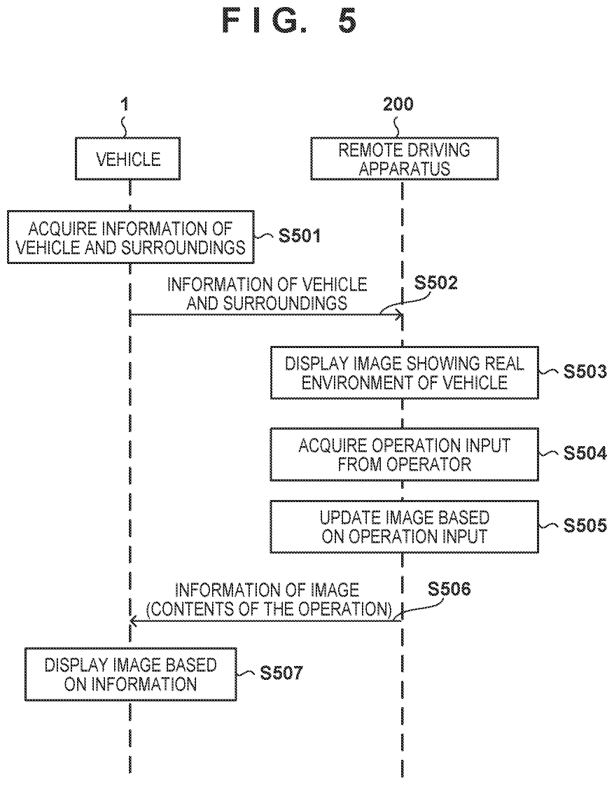

A control method of the display apparatus 92 of the vehicle 1 and the display apparatus 310 of the remote driving apparatus 200 in a remote control system will be described with reference to FIG. 5. The display apparatus 92 of the vehicle 1 may be controlled, for example, as a result of the processor 20a of the ECU 20 or the like of the vehicle 1 executing a program stored the memory 20b of the ECU 20 or the like. The display apparatus 310 of the remote driving apparatus 200 may be controlled, for example, as a result of the processor 201 of the remote driving apparatus 200 executing a program stored in the memory 202. Alternatively, in each of the vehicle 1 and the remote driving apparatus 200, some or all of the processes of the method may be performed by a dedicated integrated circuit such as an ASIC (application specific integrated circuit). In the former case, the processor serves as a constituent element for a specific operation, and, in the latter case, the dedicated circuit serves as a constituent element for a specific operation. Display control in the remote control system will be mainly described below. Other control such as running control of the vehicle 1 is similar to conventional control, and thus a description thereof is omitted. The control method in FIG. 5 is executed repeatedly while the remote driving service is being provided to the vehicle 1. A state where the remote driving service is being provided (in other words, a state where the remote driving service is being used) may refer to a state where the vehicle 1 can be operated by the operator of the remote driving apparatus 200. Alternatively, a state where the remote driving service is being used may refer to a state where the vehicle 1 can be operated by the operator of the remote driving apparatus 200 in the leading mode (an operation mode in which the operator of the remote driving apparatus 200 specifies control amounts (for example, a steering angle, an accelerator pedal position, a brake pedal position, a position of the directional signal lever, and on/off of the lights) of the vehicle). In either way, it is sufficient that the vehicle 1 can be operated by the operator of the remote driving apparatus 200, and whether or not remote driving (operation) is being actually performed does not matter.

In step S501, the vehicle 1 acquires information regarding the vehicle 1 and information regarding an object in the surroundings of the vehicle 1. The information regarding the vehicle 1 may include the current geographical location of the vehicle 1, the current speed and acceleration rate of the vehicle 1, identification information of the vehicle 1 in the remote driving service, and the like. The geographical location of the vehicle 1 may be the geographical location of a representative point that represents the vehicle 1, or the geographical location of a region in the three-dimensional space occupied by the vehicle 1.

The information regarding an object in the surroundings of the vehicle 1 may include, for example, a type of object, the current geographical location of the object, the speed and acceleration rate of the object, and a predicted future movement path of the object. The vehicle 1 determines the type and geographical location of the object based on sensor data of the object acquired by the detection units 41 to 43. Examples of the type of object include a standard-sized vehicle, a large-sized vehicle, a two-wheeled vehicle, an adult pedestrian, a child pedestrian, and a bicycle rider. The geographical location of an object may be the geographical location of a single point, or the geographical location of a region in the three-dimensional space occupied by the object. In addition, the object information providing unit 502 may calculate the speed and acceleration rate of the object based on the temporal change in the geographical location of the object. Furthermore, the object information providing unit 502 may generate a predicted future movement path of the object based on the geographical location, speed, and acceleration rate of the object. If the object is a vehicle, the object information providing unit 502 may generate a predicted future movement path of the object based further on the direction indicator, the driver's line of sight, and the like, and, if the object is a pedestrian or a bicycle rider, the object information providing unit 502 may generate a predicted future movement path of the object based further on their line of sight and the like.

In step S502, the vehicle 1 transmits, to the remote driving apparatus 200, the information regarding the vehicle 1 and the information regarding the object in the surroundings of the vehicle 1, and the remote driving apparatus 200 acquires this information by receiving it. The remote driving apparatus 200 may also acquire information regarding an object in the surroundings of the vehicle 1, not only from the vehicle 1 but also a road management camera 401.

In step S503, the remote driving apparatus 200 generates an image showing the real environment around the vehicle 1, and displays the image on the display apparatus 310 (for example, the main region 311). Specifically, the remote driving apparatus 200 reads out, from the memory 202, the geographical location of the vehicle 1 and data regarding fixed structures in the surroundings of the vehicle 1. For example, the remote driving apparatus 200 reads out map data as seen by the driver of the vehicle 1, from the memory 202. Such data is stored in the memory 202 in advance.

The remote driving apparatus 200 then determines a virtual object for representing this object, based on the type of the object included in the information regarding this object. For example, when the type of object is a standard-sized vehicle, the remote driving apparatus 200 performs determination to use a virtual object of a standard-sized vehicle in order to represent this object.

After that, the remote driving apparatus 200 may determine a display size of the virtual object based on the geographical location of the object (i.e., a region occupied in the three-dimensional space). The remote driving apparatus 200 then displays the virtual object that represents the object in the surroundings of the vehicle 1, at a display position corresponding to the geographical location of the object, in background data. This virtual object may be a model corresponding to the type of object. A specific example of an image will be described later.

In step S504, the remote driving apparatus 200 acquires operation input from the operator. As described above, the operator may be AI or the user (human) of the remote driving apparatus 200. The operation input may include, for example, an operation related to at least one of acceleration, deceleration, and/or steering. In step S505, the remote driving apparatus 200 updates the image displayed in step S503, based on the operation input.

In step S506, the remote driving apparatus 200 transmits, to the vehicle 1, information included in the image displayed in step S503, and the vehicle 1 acquires this information by receiving it. An operation instruction to the vehicle 1 may be transmitted along with this information. In addition, information regarding the operation input acquired in step S504 may be transmitted along with this information. The information regarding the operation input may include at least the state of an operation performed on an operation element by the user of the remote driving apparatus 200 and/or the content of an operation performed by the operator of the remote driving apparatus 200. “The state of an operation performed on an operation element by the user of the remote driving apparatus 200” refers to a state where the user is or is not using the operation element (the steering wheel 330, the accelerator pedal 340, the brake pedal 350, etc.) of the remote driving apparatus 200. For example, when the user is holding the steering wheel 330, the steering wheel 330 is being used regardless of the rotation amount thereof. When a foot of the user is placed on the accelerator pedal 340, the accelerator pedal 340 is being used regardless of the position thereof “The state of an operation performed on an operation element by the user of the remote driving apparatus 200” may include a state where the user of the remote driving apparatus 200 is or is not using the operation element of the remote driving apparatus 200 without applying any operation amount. The content of an operation performed by the operator of the remote driving apparatus 200 may be information that includes an operation element that is operated and the operation amount of this operation element. The content of an operation is generated by the remote driving apparatus 200 based on operation input from the operator of the remote driving apparatus 200.

In step S507, the vehicle 1 generates an image based on the information acquired in step S506, and displays the generated image on the display apparatus 92. A specific example of this image will be described later.

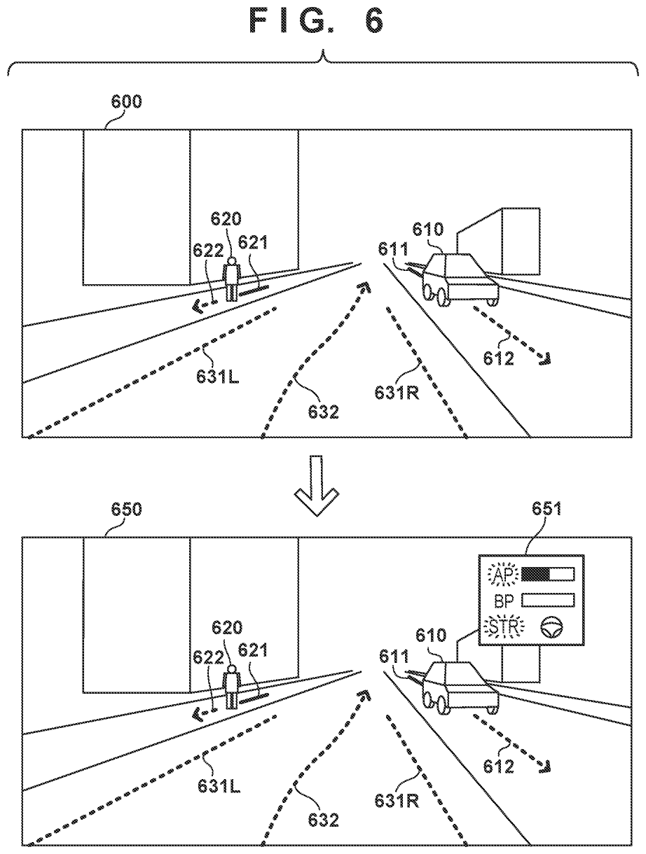

An example of an image 600 displayed on the display apparatus 310 of the remote driving apparatus 200 in step S503 and an image 650 displayed on the display apparatus 92 of the vehicle 1 in step S507 will be described with reference to FIG. 6. The image 600 virtually expresses the real environment 400 in FIG. 4. A virtual object 610 is a virtual object that represents the oncoming vehicle 402. A three-dimensional model of a vehicle is used as the virtual object. A virtual object 620 is a virtual object that represents the pedestrian 403. A three-dimensional model of an adult is used as the virtual object. These virtual objects are displayed in a map as seen by the driver of the vehicle 1, at display positions corresponding to the geographical locations of the objects. In the example in FIG. 6, a map as seen by the driver of the vehicle 1 is displayed, but, alternatively, a map in a viewpoint when the vehicle 1 is viewed from behind may be displayed. In this case, the remote driving apparatus 200 may display the virtual object that represents the vehicle 1, in the image 600.

In the image 600, a past movement path of the oncoming vehicle 402 is indicated by a solid line 611, and a predicted future movement path of the oncoming vehicle 402 is indicated by a broken line 612. The remote driving apparatus 200 generates a past movement path of the oncoming vehicle 402 based on past geographical locations of the oncoming vehicle 402. In order to generate a past movement path, the remote driving apparatus 200 may store most recent geographical locations of the oncoming vehicle 402 for a certain time period (for example, for 5 seconds). A predicted future movement path of the oncoming vehicle 402 is received in step S702, or generated in step S704, and is acquired. Similarly, in the image 600, a past movement path of the pedestrian 403 is indicated by a solid line 621, and a predicted future movement path of the pedestrian 403 is indicated by a broken line 622.

In the image 600, predicted future movement paths of the vehicle 1 are indicated by broken lines 631L and 631R. These predicted movement paths are generated by the remote driving apparatus 200 based on operation input performed by the operator of the remote driving apparatus 200. The broken line 631L indicates a predicted movement path of the left edge of the vehicle 1, and the broken line 631R indicates a predicted movement path of the right edge of the vehicle 1. By indicating the predicted movement paths of the two edges in this manner, the operator of the remote driving apparatus 200 easily recognizes the width of the vehicle 1. In addition, a recommended movement path 632 of the vehicle 1 is also displayed in the image 600. The recommended movement path 632 is generated by the remote driving apparatus 200 based on information obtained from the vehicle 1 and the road management camera 401. The recommended movement path 632 is an example of recommendation information for the user of the remote driving apparatus 200. The image 600 may show, as another example of the recommendation information, operation amounts of operation elements (the accelerator pedal 340, the brake pedal 350, and the steering wheel 330).

The image 650 that is displayed on the display apparatus 92 of the vehicle 1 includes the same information as the image 600 that is displayed on the display apparatus 310 of the remote driving apparatus 200. By displaying, for the driver of the vehicle 1, the image 650 that includes the same information as the image 600 that is being viewed by the user of the remote driving apparatus 200 in this manner, the driver can be aware of information based on which the vehicle 1 is remotely driven. Furthermore, the image 650 may also include a region 651 that indicates the state of an operation performed on the vehicle 1 by the operator of the remote driving apparatus 200 and/or the content of the operation. The region 651 may be generated by the vehicle 1 based on the state and/or content of the operation transmitted in step S506. Alternatively, a configuration may also be adopted in which the remote driving apparatus 200 generates an image of the region 651 based on the state and/or content of the operation, and the vehicle 1 that has received the image superimposes the received image onto the image 650.

In the region 651, operation elements to be operated (an accelerator pedal “AP”, a brake pedal “BP” and a steering wheel “STR”) and operation amounts of the operation elements are indicated. In addition, highlighted letters “AP” indicate that a foot of the user of the remote driving apparatus 200 is placed on the accelerator pedal 340. Similarly, highlighted letters “STR” indicate that the user of the remote driving apparatus 200 is holding the steering wheel 330. In this example, a foot of the user of the remote driving apparatus 200 is not placed on the brake pedal 350, and thus the letters “BP” are not highlighted. When the operator of the remote driving apparatus 200 is AI, display indicating that the operator of the remote driving apparatus 200 is AI may be included in the region 651. In the example in FIG. 6, the region 651 is included only in the image 650 displayed in the vehicle 1, but may also be included in the image 600 that is displayed on the remote driving apparatus 200.

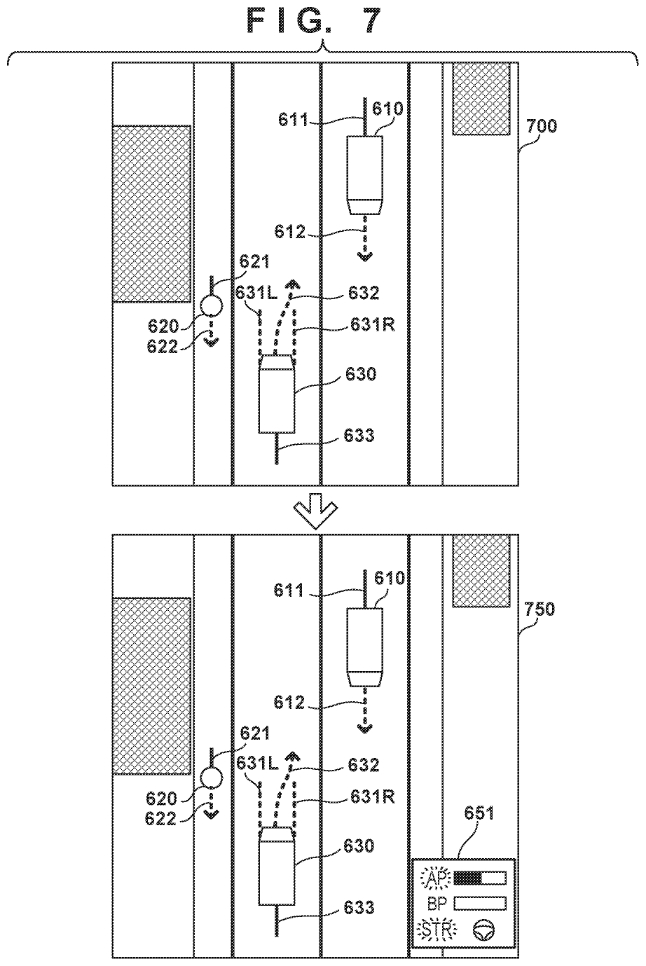

The remote driving apparatus 200 may display an image 700 in FIG. 7 in place of or at the same time as the image 600 in FIG. 6. The image 700 is a bird-eye diagram of the geographical location of the vehicle 1 and the surroundings thereof. Similarly to FIG. 6, the virtual objects 610 and 620 are displayed in a map. In the image 700, a virtual object 630 representing the vehicle 1 and a solid line 633 indicating a past movement path of the vehicle 1 are additionally displayed. The display size (entire length and entire width) of the virtual object 630 is determined according to the size of the vehicle 1. The size of the vehicle 1 may be received from the vehicle 1 in step S701, or may also be stored in the memory 202 in advance. The remote driving apparatus 200 may hide all of the solid lines 611, 621, and 633 and the broken lines 612, 622, 631L, and 632R that represent past or future movement paths, or may display only some of those lines. The vehicle 1 may also display an image 750 in FIG. 7 in place of or at the same time as the image 650 in FIG. 6.

The image 650 displayed in the vehicle 1 includes predicted movement paths (the broken lines 631L and 631R) of the vehicle 1. If these predicted movement paths represent predicted movement paths according to which the vehicle 1 will collide with a physical body (for example, another vehicle or a guard rail), the vehicle 1 does not need to display the predicted movement paths of the vehicle 1, in the image 650. Accordingly, it is possible to prevent the driver of the vehicle 1 from being unnecessarily cautious. In contrast, in a case of predicted movement paths according to which the vehicle 1 will collide with a physical body (for example, another vehicle or a guard rail), the remote driving apparatus 200 displays the predicted movement paths of the vehicle 1, in the image 600. Accordingly, the user of the remote driving apparatus 200 can be aware that it is necessary to change the course of the vehicle 1.

In above-described embodiment, a case has been described in which an operation target of the remote driving apparatus 200 is the vehicle 1. The operation target of the present invention is not limited to the vehicle 1, and the present invention can be applied to other mobile bodies. When the operation target is not a vehicle, the remote driving apparatus 200 can be generally called “remote control apparatus”.

### Overview of Embodiments

Configuration 1

A control apparatus (2) that controls a display apparatus (92) of a mobile body (1) to which a remote operation service is provided from a remote operation apparatus (200), the apparatus comprising:

an acquisition unit configured to acquire information that is generated by the remote operation apparatus and is displayed on a display apparatus (310) of the remote operation apparatus (step S506); and

a control unit configured to display the information on the display apparatus of the mobile body (step S507).

According to this configuration, a sense of safety of the user of the mobile body to which the remote operation service is provided increases.

Configuration 2

The control apparatus according to configuration 1,

wherein the information includes recommendation information (632) for a user of the remote operation apparatus.

According to this configuration, the user of the mobile body can be aware what recommendation information is displayed for the user of the remote operation apparatus.

Configuration 3

The control apparatus according to configuration 1 or 2,

wherein the information includes a state of an operation performed on an operation element by a user of the remote operation apparatus.

According to this configuration, the user of the mobile body can be aware of the state of the operation performed on the operation element by the user of the remote operation apparatus.

Configuration 4

The control apparatus according to any one of configurations 1 to 3,

wherein the information includes a predicted movement path (631L, 631R) of the mobile body that is based on operation input performed by an operator of the remote operation apparatus.

According to this configuration, the user of the mobile body can be aware of a predicted movement path of the mobile body.

Configuration 5

The control apparatus according to any one of configurations 1 to 4,

wherein the information includes content of an operation (651) of the mobile body performed by an operator of the remote operation apparatus.

According to this configuration, the user of the mobile body can be aware of content of an operation performed on the mobile body.

Configuration 6

The control apparatus according to configuration 5,

wherein the content of the operation includes an operation element that is operated and an operation amount of the operation element.

According to this configuration, the user of the mobile body can be aware of detailed content of an operation performed on the mobile body.

Configuration 7

The control apparatus according to any one of configurations 1 to 6,

wherein the information includes information indicating a width (631L, 631R, 630) of the mobile body.

According to this configuration, the user of the mobile body can be aware of the distance between the mobile body and another object.

Configuration 8

The control apparatus according to any one of configurations 1 to 7,

wherein, in a case in which the information includes a predicted movement path according to which the mobile body will collide with a physical body, the control unit does not display the predicted movement path on the display apparatus of the mobile body.

According to this configuration, the user of the mobile body does not need to be unnecessarily cautious.

Configuration 9

A non-transitory storage medium that stores a program for causing a computer to function as each unit of the control apparatus according to any one of configurations 1 to 8.

According to this configuration, each of the above configurations can be realized in a form of a storage medium that stores a program.

Configuration 10

A control method for controlling a display apparatus (92) of a mobile body (1) to which a remote operation service is provided from a remote operation apparatus (200), the method comprising:

acquiring information that is generated by the remote operation apparatus and is displayed on a display apparatus (310) of the remote operation apparatus (step S506); and

displaying the information on the display apparatus of the mobile body (step S507).

According to this configuration, a sense of safety of the user of the mobile body to which the remote operation service is provided increases.

The invention is not limited to the foregoing embodiments, and various variations/changes are possible within the spirit of the invention.

What is claimed is:

1. A control apparatus that controls a display apparatus of a mobile body to which a remote operation service is provided from a remote operation apparatus, the apparatus comprising:
an acquisition unit configured to acquire information that is generated by the remote operation apparatus and is displayed on a display apparatus of the remote operation apparatus; and
a control unit configured to display the information on the display apparatus of the mobile body.

2. The control apparatus according to claim 1,
wherein the information includes recommendation information for a user of the remote operation apparatus.

3. The control apparatus according to claim 1,
wherein the information includes a state of an operation performed on an operation element by a user of the remote operation apparatus.

4. The control apparatus according to claim 1,
wherein the information includes a predicted movement path of the mobile body that is based on operation input performed by an operator of the remote operation apparatus.

5. The control apparatus according to claim 1,
wherein the information includes content of an operation of the mobile body performed by an operator of the remote operation apparatus.

6. The control apparatus according to claim 5,
wherein the content of the operation includes an operation element that is operated and an operation amount of the operation element.

7. The control apparatus according to claim 1,
wherein the information includes information indicating a width of the mobile body.

8. The control apparatus according to claim 4,
wherein the control unit does not display the predicted movement path on the display apparatus of the mobile body.

9. A non-transitory storage medium that stores a program for causing a computer to function as each unit of the control apparatus according claim 1.

10. A control method for controlling a display apparatus of a mobile body to which a remote operation service is provided from a remote operation apparatus, the method comprising:
acquiring information that is generated by the remote operation apparatus and is displayed on a display apparatus of the remote operation apparatus; and
displaying the information on the display apparatus of the mobile body.
